(19) United States
(12) Patent Application Publication
(10) Pub. No.: US 2005/0212942 A1
(43) Pub. Date: Sep. 29, 2005

(54) Portable electronics device for displaying an image on a sheet-shaped image display

(75) Inventor: Masayuki Sakai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/088,914

(22) Filed: Mar. 25, 2005

(30) Foreign Application Priority Data
Mar. 26, 2004 (JP) 2004-091882

(51) Int. Cl. H04N 5/222

(52) U.S. Cl. 348/333.01; 348/333.06

(57) ABSTRACT

A body of an electronic camera comprises a grip portion and a passage portion. The rear of the electronic camera is provided with a power button, a decision button, mode buttons, a retracting lever and an electronic viewfinder. The top of the electronic camera is provided with a release button. The grip portion contains a battery being as a power source, and a movable image display sheet wound around the periphery thereof. The movable image display sheet is drawn out of the camera body to display images at a usage time. When the movable image display sheet is retracted, the electronic viewfinder is activated and the movable image display sheet is deactivated. When the movable image display sheet is extracted, the electronic viewfinder is deactivated and the movable image display sheet is activated.

### BACKGROUND OF THE INVENTION

1. Field of the Invention

The present invention relates to a portable electronics device, which reads out image data to display an image on a sheet-shaped image display.

2. Description of the Related Art

Recently, portable electronics devices have been rapidly popularized. The portable electronics devices are an electronic camera, a cell-phone, PDA (Personal Digital Assistance), a portable AV player (portable player for reproducing audio and visual), and so forth. In general, the portable electronics device is provided with an image display as represented by an LCD (Liquid Crystal Display).

Such a portable electronics device is required to be further downsized. It is difficult to downsize the portable electronics device employing the LCD as the conventional image display. In view of this, it is considered to employ a well-known organic EL sheet display, which uses an organic EL (electroluminescence), as the image display of the portable electronics device, such as described in Japanese Patent Laid-Open Publication Nos. 2000-180934 and 11-142190.

However, it is hardly considered to incorporate an image display sheet, which is formed in a sheet shape such as the organic EL sheet display, into the portable electronics device. It is desired to further downsize the portable electronics device by efficiently containing the image display sheet in a body thereof.

Meanwhile, sometimes the portable electronics device is put in a bag or a suit and is carried to various places. Further, the portable electronics device is sometimes used at the outside of a room. However, it is hardly considered to take measures of waterproof property, dust resistance, impact resistance and so forth in the case of incorporating the image display sheet.

### SUMMARY OF THE INVENTION

In view of the foregoing, it is a primary object of the present invention to provide a portable electronics device in which a movable image display sheet is efficiently retracted in a body to reduce its size.

It is a second object of the present invention to provide a portable electronics device having excellent waterproof properties, dust resistance and impact resistance.

In order to achieve the above and other objects, the portable electronics device according to the present invention comprises a body having a grip portion, a movable image display sheet, a battery chamber, a display-sheet containing chamber, and a draw port. The movable image display sheet displays an image and is flexible. The battery chamber is formed in the grip portion to contain a battery. The display-sheet containing chamber is formed in the grip portion so as to surround the battery chamber to drawably contain the movable image display sheet in a roll form. The draw port is formed in the grip portion to extract the movable image display sheet.

In a preferred embodiment, the maximum length of the movable image display sheet extracted from the display-sheet containing chamber is longer than a size of the body in an extracting direction of the movable image display sheet. Moreover, the portable electronics device is provided with a small-sized stationary image display disposed on the body. When the movable image display sheet is retracted, the stationary image display is displayable and the movable image display sheet is undisplayable. When the movable image display sheet is drawn out of the body, the movable image display sheet is displayable. At this time, the stationary image display may be displayable or undisplayable.

Further, it is preferable that the movable image display sheet is provided with a support member, which is disposed at an anterior end thereof in the extracting direction and is disposed along a breadth direction perpendicular to the extracting direction. The support member grants the movable image display planarity. It is preferable that a number of the images to be displayed on the movable image display sheet is changed in accordance with an extracted amount of the movable image display sheet. Alternatively, a display size of the image displayed on the movable image display sheet may be changed in accordance with the extracted amount of the movable image display sheet.

The movable image display sheet is extracted from the draw port. It is preferable to dispose a lid or a shielding member around the draw port. The lid opens and closes the draw port. When the lid is kept in an open position, the draw port is exposed. The lid seals the draw port when kept in a closed position. The shielding member has flexibility. When the movable image display sheet is drawn out, the shielding member is deformed to enable the movable image display sheet to be extracted. Further, it is preferable that a shock absorber is disposed so as to run along edges of the body including the grip portion.

According to the present invention, the movable image display sheet is efficiently retracted so that it is possible to downsize the portable electronics device.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a front perspective view of an electronic camera according to the present invention;

FIG. 2 is a rear perspective view of the electronic camera;

FIG. 3A is a top view of the electronic camera;

FIG. 3B is a bottom view of the electronic camera;

FIG. 4 is a block diagram showing an electrical structure of the electronic camera;

FIGS. 5A, 5B and 5C are illustrations for explaining that a length of a drawn image display sheet and display contents are changed;

FIGS. 6A and 6B are perspective views showing the electronic camera of the time when the length of the drawn image display sheet and the display contents are changed;

FIG. 7 is a flowchart explaining a sequence to be executed at a shooting time of the electronic camera; and

FIGS. 8A and 8B are illustrations for explaining another case in that the length of the drawn image display sheet and the display contents are changed in a different way from that of FIG. 5.

### DETAILED DESCRIPTION OF THE PREFERRED EMBODIMENT(S)

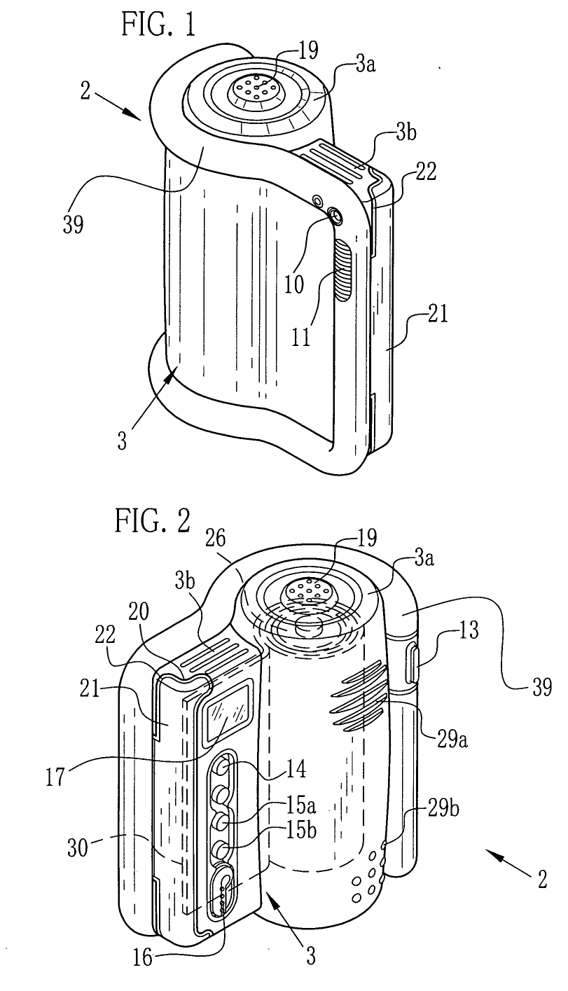

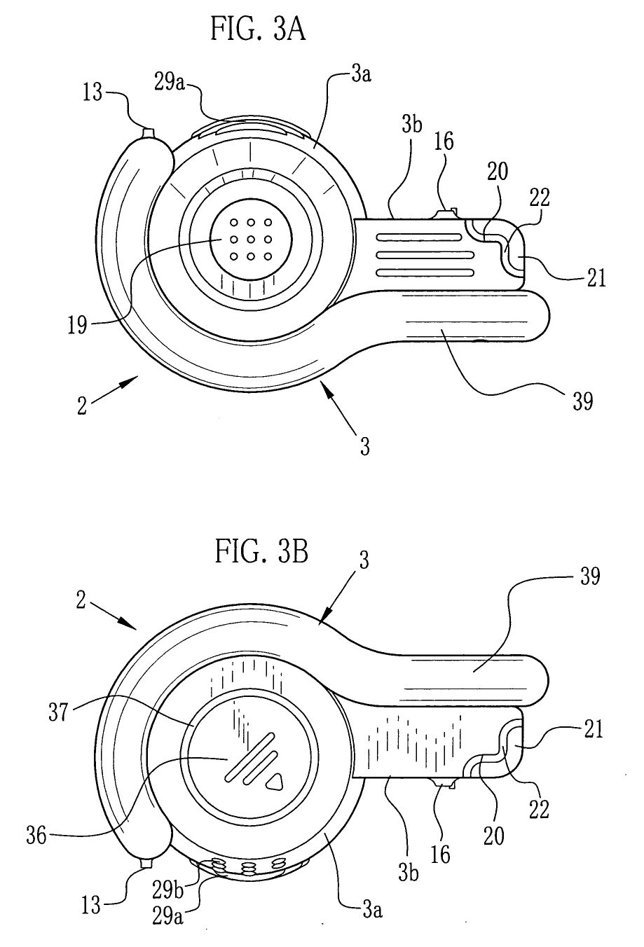

FIGS. 1 and 2 show front and rear perspective views of an electronic camera (portable electronics device) according to the present invention. A camera body 3 of the electronic camera 2 is constituted of a cylindrical grip portion 3a positioned at one side, and a parallelepiped passage portion 3b positioned at the other side, such as shown in a top view of FIG. 3A. The front of the camera body 3 is provided with a taking lens 10 and a flash window 11. The rear of the camera body 3 is provided with a power button 13, a decision button 14, mode buttons 15a and 15b, a retracting lever 16, an electronic viewfinder (small-sized image display) 17 as stationary image display, and so forth. As to the electronic viewfinder, a well-known LCD (Liquid Crystal Display) is used for example. Meanwhile, the top of the grip portion 3a is provided with a release button 19.

In the electronic camera 2, it is possible to select some modes of an imaging mode for taking a subject, a replay mode for reproducing and displaying the taken image, and so forth. Changing these modes is performed by pressing the mode buttons 15a and 15b, for example.

The passage portion 3b of the camera body 3 is formed with a draw port 20 located at a side thereof opposite to the grip portion 3a. In addition, a lid 21 for opening and closing the draw port 20 is provided. The lid 21 is attached to the passage portion 3b so as to be openable. When the lid 21 is kept in an open position, the draw port 20 is exposed. When the lid 21 is kept in a closed position, the draw port 20 is sealed.

A peripheral portion of the lid 21 is provided with an elastic member 22 for closing a gap formed between the draw port 20 and the lid 21, such as shown in FIG. 3. In virtue of this, when the lid 21 is kept in the closed position, the gap formed between the draw port 20 and the lid 21 is sealed so that it is possible to possess excellent waterproof property and excellent dust resistance. The elastic member 22 is formed from a rubber, a soft resin and so forth.

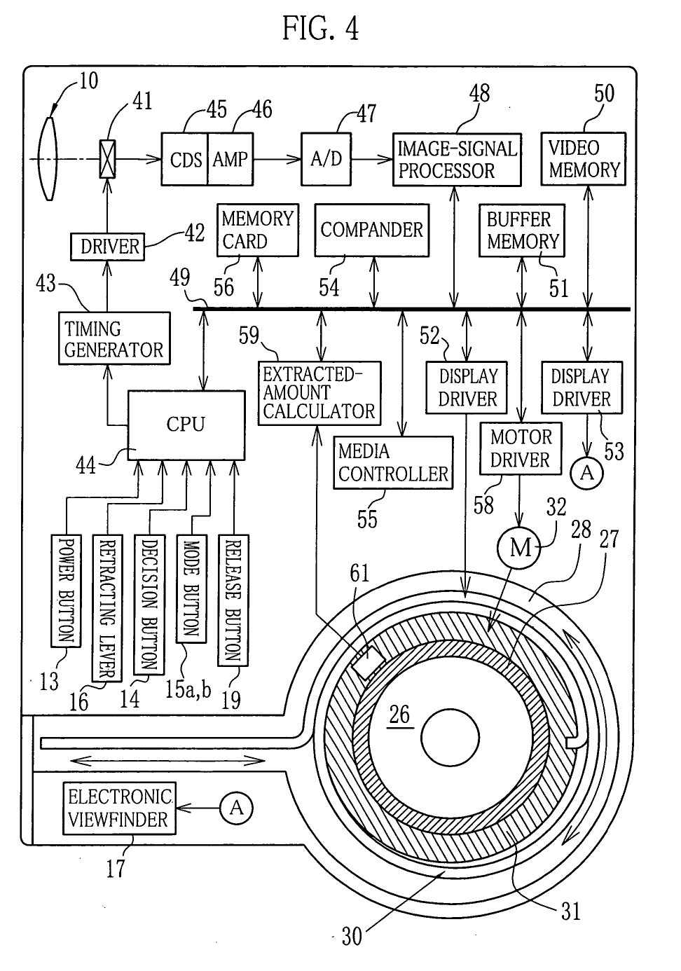

The camera body 3 is provided with a battery chamber 27 and a display-sheet chamber 28 (see FIG. 4) formed inside the grip portion 3a. The battery chamber 27 contains a battery 26 used for power supply, and the display-sheet chamber 28 is arranged so as to surround the battery chamber 27. Meanwhile, the rear of the grip portion 3a is formed with a plurality of ribs 29a and protrusions 29b as slip stoppers.

The electronic camera 2 comprises a movable image display sheet 30 having a sheet shape and flexibility. As to the movable image display sheet 30, is used for example a well-known organic EL (electroluminescent) sheet display utilizing an organic EL display. Such as described later, the movable image display sheet 30 is used as a monitor for reproducing an image under the replay mode, and is used as a viewfinder for displaying a through image of a shooting image under the imaging mode.

As shown in FIG. 4, the movable image display sheet 30 is wound around a spool 31 disposed inside the display-sheet chamber 28 and is contained in the display-sheet chamber 28. The spool 31 is rotatably attached to the periphery of the battery chamber 27. A motor 32 is connected to the spool 31 via a one-way clutch, for example. Upon operation of the retracting lever 16, the motor 32 is driven and the one-way clutch is set to a connection state so that the drive of the motor 32 is transmitted to the spool 31 to rotate this spool 31 in a take-up direction (in a clockwise direction in the drawing). Thus, the movable image display sheet 30 is wound around the spool 31 and is retracted into the display-sheet chamber 28. Meanwhile, when the movable image display sheet 30 is drawn out, the one-way clutch is set to a release state so that the spool 31 is rotated in an extracting direction (in a counterclockwise direction in the drawing) in association with the extraction of the movable image display sheet 30. Incidentally, the drive source for taking up the movable image display sheet 30 into the grip portion 3a is not limited to the motor 32. For example, a torsion coil spring and so forth may be incorporated inside the grip portion 3a, and the movable image display sheet 30 may be taken up by rotating the spool 31 in the take-up direction.

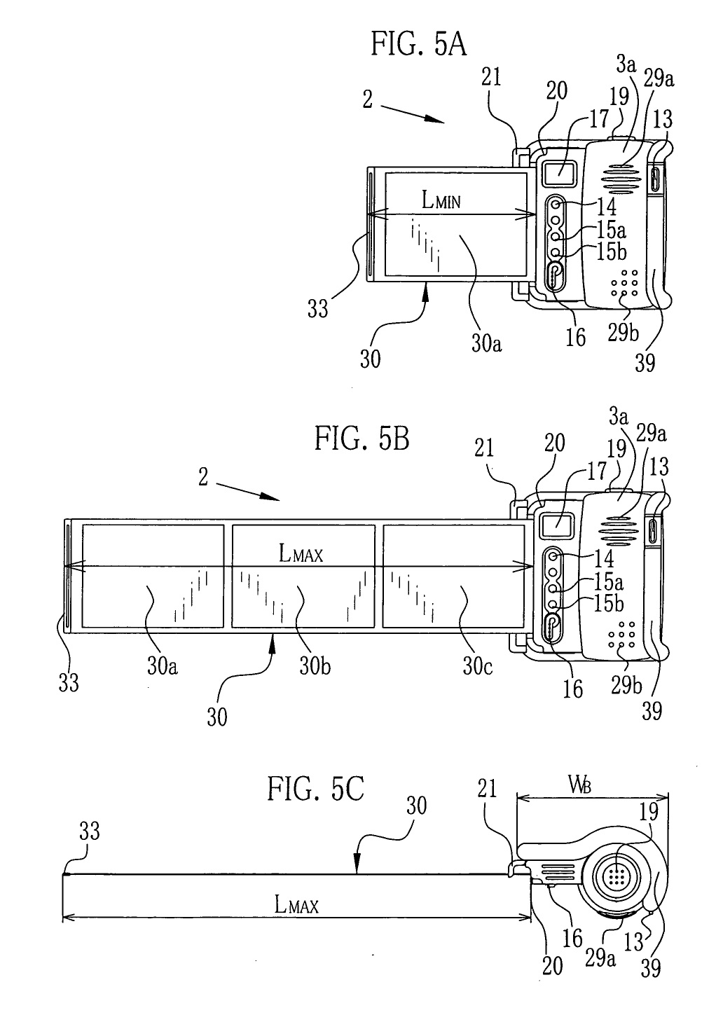

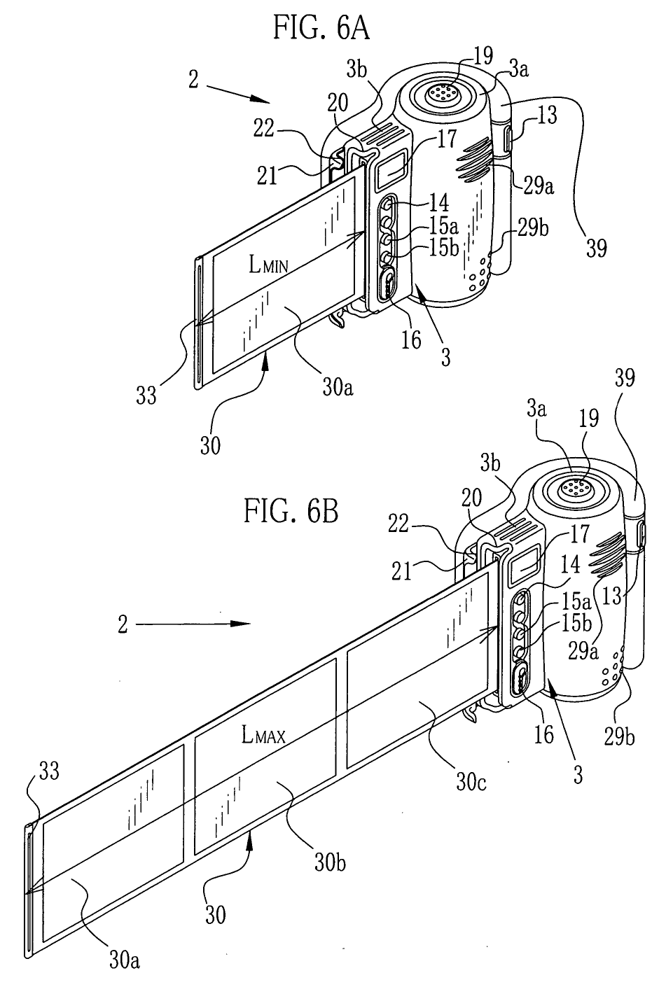

When using the movable image display sheet 30, the lid 21 is set to the open position and the movable image display sheet 30 is drawn out of the camera body 3, such as shown in FIGS. 5 and 6. Consequently, display screens 30a to 30c of the movable image display sheet 30 are exposed. In contrast, when the movable image display sheet 30 is not used, the movable image display sheet 30 is wound around the spool 31 and is contained inside the display-sheet chamber 28. The lid 21 is set to the closed position.

As shown in FIG. 5, when the movable image display sheet 30 is drawn out of the camera body 3, the maximum length LMax thereof is longer than a width WB of the camera body 3 (a size of the camera body 3 in the extracting direction of the movable image display sheet 30). Thus, in this embodiment, it is possible to arrange the image display having a larger size than the width of the camera body 3. The rear of the movable image display sheet 30 is provided with the display screens 30a to 30c. In this embodiment, it is possible to display images on the respective frames of the display screens 30a to 30c. Incidentally, although the movable image display sheet is provided with the three display screens in this embodiment, the number of the display screens is not limited to three.

An anterior end of the movable image display sheet 30 in the extracting direction thereof is provided with a support member 33, which is disposed in a breadth direction of the movable image display sheet 30 perpendicular to the extracting direction to support the movable image display sheet 30. In virtue of the support member 33, the movable image display sheet 30 can keep planarity, and it is possible to display the images on the display screens 30a to 30c having the planarity when the movable image display sheet 30 is drawn out of the camera body 3.

In the meantime, the bottom of the grip portion 3a is provided with a battery-chamber cover (grip-portion cover) 36 such as shown in a bottom view of FIG. 3B. The battery-chamber cover 36 is attached to the grip portion 3a so as to be openable. When the battery-chamber cover 36 is kept in an open position, the battery chamber 27 is exposed. When the battery-chamber cover 36 is kept in a closed position, the battery chamber 27 is sealed. Similarly to the lid 21, the battery-chamber cover 36 is provided with an elastic member 37, which is located at a periphery thereof to close a gap. By means of the elastic member 37, when the battery-chamber cover 36 is kept in the closed position, it is possible to seal the inside of the grip portion 3a and to maintain excellent waterproof property and excellent dust resistance. It is preferable that the elastic member 37 is formed from a rubber of an O-ring and soft resin.

Further, the camera body 3 is provided with a shock absorber 39, which is disposed so as to run along edges of the grip portion 3a and the passage portion 3b. The shock absorber 39 is formed in a pipe shape having a circular section, and is disposed throughout the whole of the camera body 3.

FIG. 4 is a block diagram showing an electrical structure of the electronic camera 2. A solid-state imaging device 41 comprising a CCD image sensor, a CMOS image sensor and so forth is disposed behind the taking lens 10. Subject light having passed through the taking lens 10 is converted into an image signal by the solid-state imaging device 41 connected to a CPU 44, which controls the entire electronic camera 2, via a driver 42 and a timing generator 43. The CPU 44 controls the driver 42 and the timing generator 43 to actuate the solid-state imaging device 41.

The image signal outputted from the solid-state imaging device 41 is inputted into a correlation double sampling circuit (CDS) 45. The CDS 45 outputs the image signal, which has been inputted from the solid-state imaging device 41, as image data of R, G and B accurately corresponding to an accumulated charge amount of each cell of the solid-state imaging device 41. The image data outputted from the CDS 45 is amplified by an amplifier (AMP) 46. An A-D converter 47 converts the image data, which has been amplified by the AMP 46, into digital image data to be transferred to an image-signal processor 48.

The image-signal processor 48 is connected to the CPU 44 via a data bus 49. The CPU 44 controls the image-signal processor 48 to perform various processes of gradation conversion, white-balance correction, gamma correction and so forth for the image data. Further, the image-signal processor 48 is connected to a video memory 50 and a buffer memory 51 via the data bus 49. The video memory 50 temporarily stores image data of low resolution, which has been transferred from the image-signal processor 48, when the electronic viewfinder 17 and the movable image display sheet 30 are used as a viewfinder. The image data stored in the video memory 50 is transferred to a display driver 52 or 53 via the data bus 49, and is displayed on the electronic viewfinder 17 or on the movable image display sheet 30. The buffer memory 51 temporarily stores the image data of high resolution. The image data read from the buffer memory 51 is compressed by a compander 54, which is connected via the data bus 49, in a compression format of JPEG and so forth. The CPU 44 controls a media controller 55 to store the compressed image data in a memory card 56.

A motor driver 58 and an extracted-amount calculator 59 are connected to the CPU 44. The motor driver 58 controls the motor 32 linked to the spool 31. The extracted-amount calculator 59 is linked to an encoder 61 built in the spool 31. The encoder 61 detects a rotational amount of the spool 31 and sends this rotational amount to the extracted-amount calculator 59. On the basis of the rotational amount of the spool 31, the extracted-amount calculator 59 calculates an extracted length L of the movable image display sheet 30.

The release button 19, the decision button 14, the mode buttons 15a and 15b, the retracting lever 16 and the power button 13 are connected to the CPU 44, and in association with operations thereof, the CPU 44 obtains instructions from a user. When the instruction for reproducing the recorded image has been obtained from the user, the CPU 44 controls the media controller 55 to read the image data from the memory card 56. The CPU 44 controls the display driver 52 or 53 to display the image, which is based on the expanded image data, on the electronic viewfinder 17 or on the movable image display sheet 30.

In the electronic camera 2, one of the electronic viewfinder 17 and the movable image display sheet 30 is set to an activation state, and the other thereof is set to a deactivation state. By using either of them set in the activation state, the through image is displayed under the imaging mode and the image is reproduced under the replay mode. The activation state and the deactivation state of the electronic viewfinder 17 and the movable image display sheet 30 are changed in association with the extruding operation of the movable image display sheet 30. In other words, when the movable image display sheet 30 is taken up in the display-sheet chamber 28, the CPU 44 controls the display drivers 52 and 53 such that the movable image display sheet is kept in the deactivation state and the electronic viewfinder is kept in the activation state. When the movable image display sheet 30 is drawn out, the CPU 44 detects the extracted image display sheet 30 from the extracted amount, which is calculated by the calculator 59. Upon detection of the extracted image display sheet 30, the CPU 44 controls the display drivers 52 and 53 such that the movable image display sheet 30 is kept in the activation state and the electronic viewfinder 17 is kept in the deactivation state. Meanwhile, when the motor 32 is driven by the operation of the retracting lever 16 to rotate the spool 31 in the take-up direction, the extracted image display sheet 30 is taken up around the spool 31 and is retracted. At this time, when the extracted-amount calculator 59 has detected that the movable image display sheet 30 is in the retraction state (the extracted amount is zero), the CPU 44 sets the movable image display sheet 30 to the deactivation state and sets the electronic viewfinder 17 to the activation state.

As to the electronic camera 2, a number of the images to be displayed changes in accordance with an extracted amount L of the movable image display sheet 30. Concretely, such as shown in FIGS. 5A and 6A, when the movable image display sheet 30 is drawn out by an extracted amount LMin corresponding to one frame, only the display screen 30a is activated to display the sole image. When the extracted amount corresponds to two frames, two display screens 30a and 30b are activated to display two images. Further, when the extracted amount is maximum, or LMax, all of the display screens 30a to 30c are activated such as shown in FIGS. 5B and 6B to display the respective images thereon.

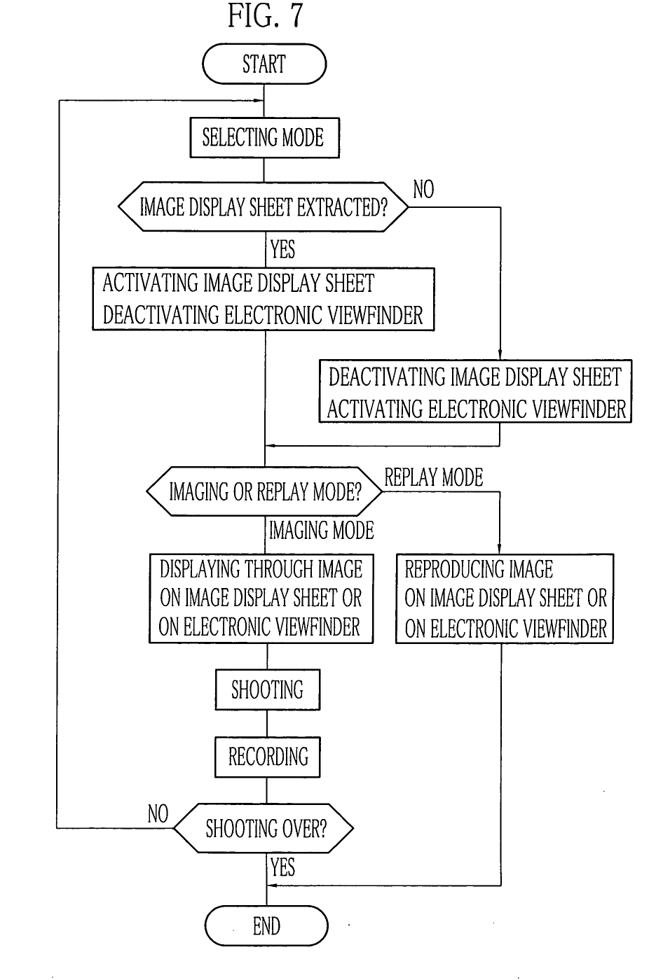

An operation of the above structure is described below on the basis of a flowchart shown in FIG. 7. First of all, one of the replay mode and the imaging mode is selected by the operation of the mode buttons 15a and 15b. Successively, the user selects the state of the movable image display sheet 30, namely selects the extracted state or the retracted state, in accordance with surrounding image-pickup conditions. At this time, when it is difficult to draw out the movable image display sheet 30 in crowds or the like, the movable image display sheet 30 is maintained in the retracted state. By contrast, in a case of outdoor where there are many spaces, the movable image display sheet 30 is drawn out.

When the movable image display sheet 30 is drawn out, the movable image display sheet 30 is kept in the activation state and the electronic viewfinder 17 is kept in the deactivation state, such as described above. The movable image display sheet 30 shows the through image when the imaging mode is selected. The user performs framing, viewing the though image, and depresses the release button 19. Upon depression of the release button 19, the image data is captured in the memory card 56 and taking one image is completed. Meanwhile, when the replay mode is selected, the image stored in the memory card 56 is read out and is reproduced on the movable image display sheet 30.

In the meantime, when the movable image display sheet 30 is retracted, the electronic viewfinder 17 is kept in the activation state and the movable image display sheet 30 is kept in the deactivation state, such as described above. Under the imaging mode, taking an image is performed while the through image is displayed on the electronic viewfinder 17. Under the replay mode, the reproduced image is displayed on the electronic viewfinder 17.

In this way, it is possible to use the electronic camera 2 in the condition that the movable image display sheet 30 is extracted or is retracted. When the movable image display sheet 30 is retracted, the electronic viewfinder 17 is used. The movable image display sheet 30 is used when drawn out. Thus, it is possible to use the electronic camera 2 in different usage patterns in accordance with the image-pickup conditions. When the movable image display sheet 30 is retracted, the electronic camera 2 is compact and has excellent portability. When the movable image display sheet 30 is drawn out, the image is shown on the display screen of the movable image display sheet 30, which is larger than the camera body 3, so that the image becomes visible. This is convenient for framing of shooting and confirmation of the reproduced image.

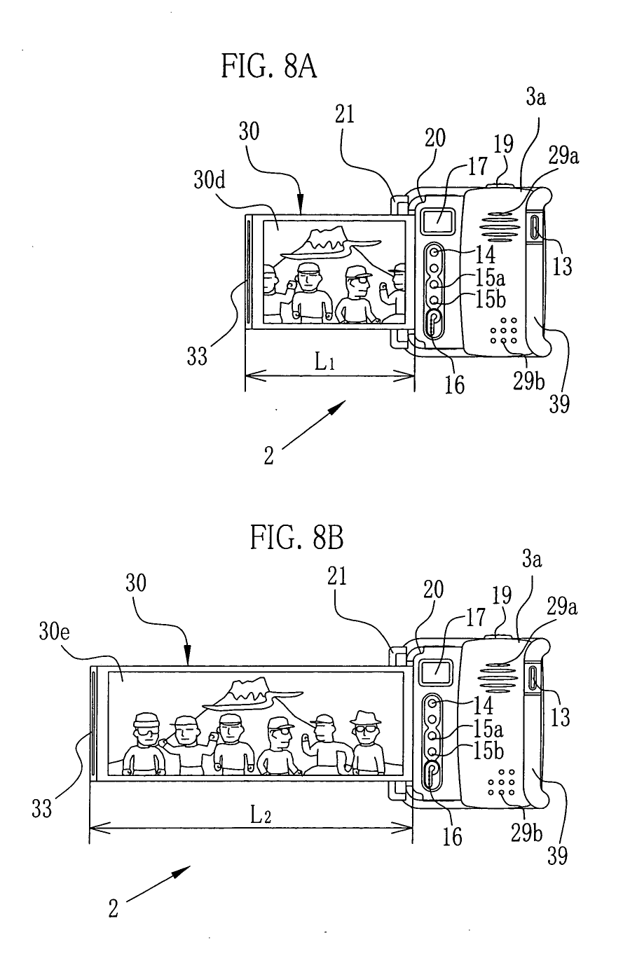

In the above embodiment, the number of the display screens for showing the images is changed in accordance with the extracted amount of the movable image display sheet 30. However, the present invention is not limited to this. A display size of the image may be changed in accordance with the extracted amount of the movable image display sheet 30. In this case, when the movable image display sheet 30 is drawn out by a normal extracted amount L1 shown in FIG. 8A, the image is displayed in a normal screen size 30d. When the movable image display sheet 30 is further drawn out to make the extracted amount thereof L2 (L2>L1), display contents of the movable image display sheet 30 is changed so as to display the image in a landscape wide-screen size 30e. By the way, the normal screen size may be set to a so-called hi-vision size (aspect ratio is 9:16), and the wide-screen size may be set to a panorama size (aspect ratio is 1:3). The display contents may be changed in accordance with the extracted length corresponding to the above-noted ratio.

In the above embodiment, the lid 21 attached to the camera body so as to be openable is provided as the member for closing the draw port 20 of the movable image display sheet 30. However, this is not exclusive. The lid 21 may be a shielding member of plush, for example. In this case, the lid 21, namely the shielding member, is formed from an elastic material having flexibility and shields the draw port 20 when the movable image display sheet 30 is not used. When the movable image display sheet 30 is used, the shielding member is elastically deformed to enable the movable image display sheet 30 to be drawn out.

In the above embodiment, the electronic camera is described as the portable electronics device. However, the present invention is not exclusive to this, but may be applied to the other portable electronics devices of a personal computer, a cell-phone with a camera, a personal digital assistance (PDA), a personal AV player and so forth.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A portable electronics device having a function for reproducing an image, comprising:
a body having a grip portion;
a movable image display sheet for displaying said image, said movable image display sheet being flexible;
a battery chamber formed in said grip portion to contain a battery;
a display-sheet containing chamber formed in said grip portion so as to surround said battery chamber to drawably contain said movable image display sheet in a roll form; and
a draw port formed in said grip portion to extract said movable image display sheet.

2. A portable electronics device according to claim 1, wherein a maximum length of said movable image display sheet extracted to the outside of said display-sheet containing chamber is longer than a size of said body in an extracting direction.

3. A portable electronics device according to claim 1, further comprising:
a small-sized stationary image display disposed on said body, said stationary image display being displayable and said movable image display sheet being undisplayable when said movable image display sheet is taken up in said display-sheet containing chamber, and said movable image display sheet being displayable when said movable image display sheet is extracted from said display-sheet containing chamber.

4. A portable electronics device according to claim 1, further comprising:
a support member disposed at an anterior end of said movable image display sheet in an extracting direction thereof, said support member being disposed in a breadth direction perpendicular to said extracting direction to grant said movable image display sheet planarity.

5. A portable electronics device according to claim 1, wherein a number of the images to be displayed on said movable image display sheet is changed in accordance with an extracted amount of said movable image display sheet.

6. A portable electronics device according to claim 1, wherein a display size of the image displayed on said movable image display sheet is changed in accordance with an extracted amount of said movable image display sheet.

7. A portable electronics device according to claim 1, further comprising:
a lid for opening and closing said draw port, said draw port being exposed when said lid is kept in an open position, and said draw port being sealed when said lid is kept in a closed position.

8. A portable electronics device according to claim 7, wherein an elastic member is attached to a peripheral portion of said lid to seal a gap formed between said lid and said draw port.

9. A portable electronics device according to claim 7, further comprising:
a cover for opening and closing said battery chamber to exchange said battery.

10. A portable electronics device according to claim 1, further comprising:
a flexible shielding member for shielding said draw port, said shielding member being deformed to enable said movable image display sheet to be extracted at the time of extraction of said movable image display sheet.

11. A portable electronics device according to claim 1, further comprising:
a shock absorber disposed so as to run along edges of said body including said grip portion.

12. A portable electronics device according to claim 11, wherein said shock absorber is formed by a pipe having a circular section.

13. A portable electronics device according to claim 3, wherein said movable image display sheet is an organic EL sheet display.

14. A portable electronics device according to claim 13, wherein said stationary image display is a liquid-crystal display.

15. A portable electronics device according to claim 1, further comprising:
an imaging device for taking an image;
an image processor for processing the taken image;
a storage medium for storing the image for which image processing has been performed; and
a reproducer for reproducing the image read from said storage medium, on one of said movable image display sheet and said stationary image display.
